(19) United States
(12) Patent Application Publication
(10) Pub. No.: US 2019/0350407 A1
(43) Pub. Date: Nov. 21, 2019

(54) ELECTRONIC OVEN WITH VERTICALLY ACTUATED CHAMBER DOOR

(71) Applicant: The Markov Corporation, Dover, DE (US)

(72) Inventors: Roger Sharpe, Mountain View, CA (US); Leonard Robert Speiser, Los Altos, CA (US); J. Efrain Alcorta, Austin, TX (US); Scott M. DeWinter, Oakland, CA (US); Christopher Loew, Palo Alto, CA (US)

(73) Assignee: The Markov Corporation, Dover, DE (US)

(21) Appl. No.: 16/267,048

(22) Filed: Feb. 4, 2019

Related U.S. Application Data
(60) Provisional application No. 62/673,007, filed on May 17, 2018.

(51) Int. Cl. A47J 37/06

(52) U.S. Cl. CPC A47J 37/0629; A47J 37/0664

(57) ABSTRACT

Method and systems related to vertically actuated heating chamber doors are disclosed. One system includes an electronic oven, comprising a hinge mechanism, a heating chamber, a chamber door connected to the hinge mechanism, and an integrated touch display on the chamber door. The chamber door seals the heating chamber in a closed state and reveals the heating chamber in an open state. The hinge mechanism is configured to move the chamber door vertically between the open state and the closed state.

### CROSS REFERENCE TO RELATED APPLICATIONS

This application claims priority to U.S. Provisional Application No. 62/673,007, filed May 17, 2018, which is incorporated by reference herein in its entirety for all purposes.

### BACKGROUND OF THE INVENTION

Electronic ovens heat items within a chamber by bombarding them with electromagnetic radiation. In the case of microwave ovens, the radiation most often takes the form of microwaves at a frequency of either 2.45 GHz or 915 MHz. In order for the electronic oven to efficiently deliver energy to an item in the heating chamber, and to assure safe operation of the electronic oven, the heating chamber needs to be designed to prevent leakage of the electromagnetic radiation out of the chamber. To achieve this result, any opening to the chamber that is permeable to electromagnetic radiation needs to serve as a filter for electromagnetic radiation at and around the frequency of the radiation used for heating. For example, a traditional electronic oven includes a conductive mesh pattern built into the microwave chamber door to allow electromagnetic radiation in the form of visible light to exit the chamber, while serving as a radio frequency (RF) blocker to prevent leakage of the radiation delivered by the microwave energy source of the electronic oven.

There are numerous safety requirements placed on the design of an electronic oven in light of the need to prevent leakage of energy. For example, FDA HHS 21 C.F.R. § 1030.10 places a power density limit on the energy measured at 5 centimeters or more from the external surface of the oven. Additional requirements applicable to the design of electronic oven chamber doors can be found throughout 21 CFR subchapter J. As another example, the Underwriters Laboratories (UL) 923 standard places restrictions on interlock monitor endurance, door assembly tests, and microwave radiation emission tests. The chamber door of the electronic oven is a critical component for these standards and needs to be designed to assure that the electronic oven is both safe and reliable.

Traditional electronic ovens, such as microwaves, tend to include a left-side-hinged opening for ease of operation by right-handed operators, and to match expectations associated with traditional side-open ovens. However, there are also electronic ovens that are hinged at the bottom and swing down like a traditional wall oven. Also, there are microwave ovens that lift open in a vertical direction. However, available vertical-lift electronic ovens present a small heating chamber opening when the electronic oven is in an open state that limits easy access to the chamber.

### SUMMARY

Method and systems related to vertically actuated heating chamber doors are disclosed. One system includes an electronic oven, comprising a hinge mechanism, a heating chamber, a chamber door connected to the hinge mechanism, and an integrated touch display on the chamber door. The chamber door seals the heating chamber in a closed state and reveals the heating chamber in an open state. The hinge mechanism is configured to move the chamber door vertically between the open state and the closed state.

One system includes an electronic oven having an electronic oven height in a vertical direction, comprising a hinge mechanism, a heating chamber, and a chamber door connected to the hinge mechanism and having a chamber door height in the vertical direction. The chamber door is configured to seal the heating chamber in a closed state and reveal the heating chamber in an open state. The hinge mechanism is configured to move the chamber door between the open state and the closed state in a vertical direction. The chamber door height is at least sixty percent of the electronic oven height.

One system includes an electronic oven, comprising a hinge mechanism including a first hinge and a second hinge, a heating chamber, a chamber door, and an integrated touch display on the chamber door. The chamber door is connected to the first hinge on a left side of the heating chamber and the second hinge on a right side of the heating chamber.

### BRIEF DESCRIPTION OF THE DRAWINGS

FIG. 1 illustrates an electronic oven in accordance with some of the approaches disclosed herein in a closed state and an open state.

FIG. 2 illustrates an electronic oven and a portion of a hinge mechanism of the electronic oven in accordance with some of the approaches disclosed herein in both a closed state and an open state.

FIG. 3 illustrates a detailed view of a hinge in an electronic oven in accordance with some of the approaches disclosed herein.

FIG. 4 illustrates three views of the hinge in FIG. 3 as it transitions between a closed state and an open state.

FIG. 5 illustrates a detailed view of another hinge in an electronic oven in accordance with some of the approaches disclosed herein.

FIG. 6 illustrates three views of the hinge in FIG. 5 as it transitions between a closed state and an open state.

FIG. 7 illustrates a power routing system for a hinge mechanism in accordance with some of the approaches disclosed herein.

FIG. 8 illustrates the operation of a hinge cutout sealing mechanism in accordance with some of the approaches disclosed herein.

### DETAILED DESCRIPTION OF THE EMBODIMENTS

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the scope thereof. For instance, features illustrated or described as part of one embodiment may be used with another embodiment to yield a still further embodiment. Thus, it is intended that the present subject matter covers all such modifications and variations within the scope of the appended claims and their equivalents.

This following disclosure provides detailed examples of electronic ovens with vertically actuated heating chamber doors that are in accordance with embodiments of the present invention. The heating chamber door of an electronic oven seals the heating chamber in a closed state and reveals the heating chamber in an open state. A sealed heating chamber is one in which the energy applied to the item in the heating chamber is not able to leak from the chamber to any appreciable degree. A revealed heating chamber is one that can be accessed by an operator to either remove or add an item to the heating chamber. Vertically actuated heating chamber doors are those in which the entire door is translated vertically when the electronic oven transitions between the open state and the closed state. Vertically actuated heating chamber doors generally do not favor right or left-handed operators and can efficiently meet the space requirements of busy home or commercial kitchens.

In specific embodiments disclosed herein, the electronic oven presents a small ratio between the height of the electronic oven, and the size of the opening provided to the heating chamber when the electronic oven is in an open state. In other words, the chamber door is designed such that it reveals a large opening relative to the overall size of the electronic oven to facilitate convenient access to the heating chamber. These embodiments include approaches in which the heating chamber door is attached to a hinge mechanism on the lower half of the chamber door. Specific approaches disclosed herein below also allow for such a chamber door and hinge mechanism to be actuated with a minimal degree of force applied consistently through the transition of the electronic oven between the closed state and the open state.

In specific embodiments disclosed herein, the electronic oven chamber door includes an integrated display. The display can utilize a standard LCD, LED, plasma, or other display technology. The display can be an integrated touch display on the chamber door used to provide information to or accept commands from an operator of the electronic oven. Power can be routed to the chamber door via a hinge mechanism. Data can also be routed to and from the chamber door via the hinge mechanism. In certain approaches, the integrated display will remain facing towards an operator in both the open and closed states of the electronic oven. As a result, useful information can be continuously presented to an operator or those in the vicinity of the electronic oven.

Specific embodiments disclosed herein include a combination of features from the preceding two paragraphs. Specifically, the chamber door includes an integrated display, and the way the door is opened assures that the display is facing out and away from the electronic oven in both the open and closed states. As such, useful information can be viewed on the display in both the open and closed state. This aspect is important because the chamber door of an electronic oven in a busy commercial setting is beneficially left open to increase the speed at which the oven is operated, and useful information can be presented to other people near the electronic oven via the integrated display when the electronic oven is open. In specific embodiments disclosed herein, both the potential vertical and horizontal dimension of the chamber door are maximized such that a large area is provided for the display of information. Indeed, since the integrated display can in some cases be a touch display that receives command from the user, the display can provide a sole control panel for the electronic oven and there is no need to save surface area for a separate control panel on the electronic oven.

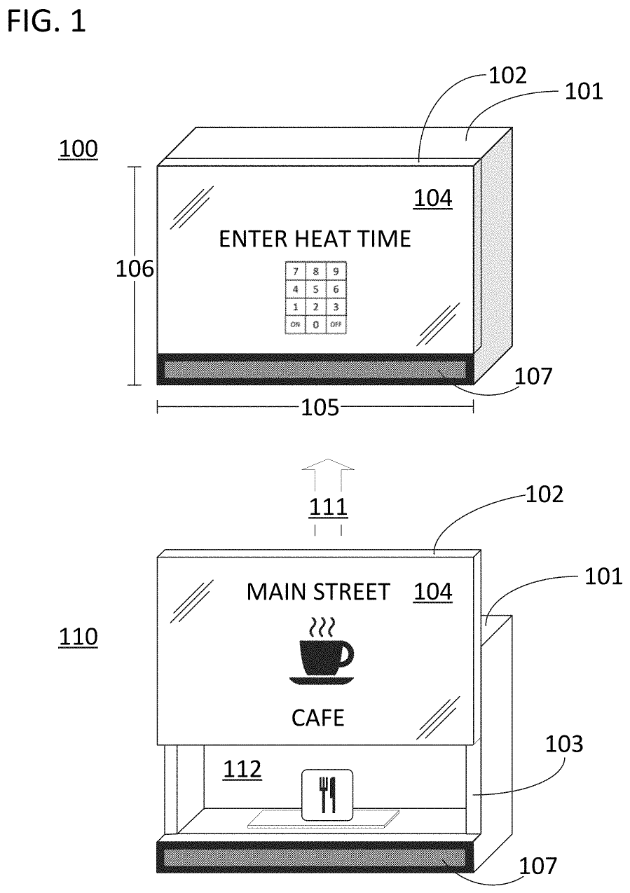

FIG. 1 illustrates an electronic oven that is in accordance with specific embodiments of the present invention. The electronic oven is illustrated in a closed state 100 and an open state 110. The electronic oven includes a main body 101 and a chamber door 102. The main body 101 can include an exterior shell and an oven core 103 located between the exterior shell and heating chamber. Oven core 103 can include the control systems of the electronic oven, a ventilation system for the electronic oven, an energy source (such as a magnetron) for the electronic oven, and a waveguide that couples the energy source to an injection port in the heating chamber.

The chamber door can include an integrated display 104. As illustrated, the chamber door can cover the entire lateral extent of the electronic oven 105. Integrated display 104 is more specifically an integrated touch display that serves as the sole controller for the electronic oven and can receive commands from the user. As such, there is no need to save room for an additional controller on the front surface of the electronic oven and the integrated display 104 and chamber door 102 can extend across an entire lateral extent of the electronic oven 105. In accordance with this disclosure, the chamber door can also cover the entire vertical extent of the electronic oven 106. However, in the illustrated case, chamber door 102 does not cover the entire vertical extent of the electronic oven 106 as it leaves room for a ventilation system 107 of the electronic oven on a front side of the electronic oven.

A chamber door in accordance with embodiments of the present disclosure can be actuated in a vertical direction using any means for actuation. The means for actuation can translate the entire chamber door in a vertical direction. For example, chamber door 102 is actuated in a vertical direction relative to the height of the electronic oven 111 when the electronic oven transitions from closed state 100 to open state 110. When in open state 110, the heating chamber of the electronic oven 112 is accessible to place items in the heating chamber or to remove them from the heating chamber.

Means for actuation used in accordance with this disclosure can include structures that initiate, guide, assist, and control a vertical translation of the chamber door. The means for actuation can be an active system such as a pneumatic lift, spring, or counterweight to assist the translation. The means for actuation can, alone or in combination, include, a hinge or slide track to guide the translation. The means for actuation can also include a handle or grip used to provide mechanical force to initiate and/or assist the translation. The chamber door of an electronic oven will generally be required to be locked in place when the electronic oven is in a closed state. Accordingly, the means for actuation can operate in combination with a digital system or a mechanical switch to allow a user to initiate translation. The switch can include a hook-and-socket, hook-and-roller, magnetic, tension, slide barrel, or other latch which is disconnected to initiate the translation. In a specific implementation, the means for actuation will include both a handle or grip and a pneumatic lift, spring, or counterweight such that external mechanical force will be used to translate the chamber door, but the door will feel nearly weightless during that translation. In these approaches, the pneumatic lift, spring, or counterweight can be designed to maintain the chamber door at any height once the external mechanical force is removed. Alternatively, the pneumatic lift, spring, or counterweight can be designed to maintain the chamber door in the open state only when the door has been moved all the way into a fully open state.

A chamber door in accordance with embodiments of the present disclosure can be designed to maintain itself in an open state in the absence of external force. As illustrated, the electronic oven in open state 110 is not receiving external force to maintain chamber door 102 in the position it was vertically translated too. As a result, chamber 112 remains accessible for the next use, and both the current and subsequent users are saved a step in the process of using the oven (i.e., the current user does not need to close the oven, and the subsequent user does not need to open the oven). Although this may seem like a miniscule amount of work, in a busy commercial kitchen, the cumulative savings in labor time and decreased wear on the equipment can be appreciable. Additionally, as opposed to a side hinged or pull-down chamber opening, the vertically actuated chamber door is conducive to use in space-constrained operations in that the top-down foot print of the electronic oven is not modified to any appreciable degree while the electronic oven is opened. Additionally, since the display on the chamber door is presented in a prominent location and is facing away from the electronic oven, integrated display 104 can be used to present information such as a promotional message, a store menu, or a general informational message to patrons near the electronic oven while the electronic oven is open.

The dimensions of the electronic oven and means of actuation can be selected to maximize the size of the heating chamber opening and/or the size of any integrated display located on the surface of the heating chamber door. In specific embodiments of the present invention, the size of the heating chamber opening will be close to the height of the electronic oven. In specific embodiments of the present invention, the means for actuating the chamber door will include a connection between the chamber door and the main body of the electronic oven. In specific embodiments, this connection will be on the lower half of the chamber door. For example, a hinge mechanism or a slide track could be attached to the chamber door on the lower half of the chamber door. The means for actuation could also be configured to cause at least half of the chamber door to be located above a top surface of the electronic oven when the electronic oven is in the open state to assure that a relatively large opening is provided for accessing the heating chamber. In specific embodiments of the present invention, the chamber door could additionally, or in the alternative, have a height that is at least sixty percent of the electronic oven height in order to present a large surface area for a display on the electronic oven relative to the size of the electronic oven.

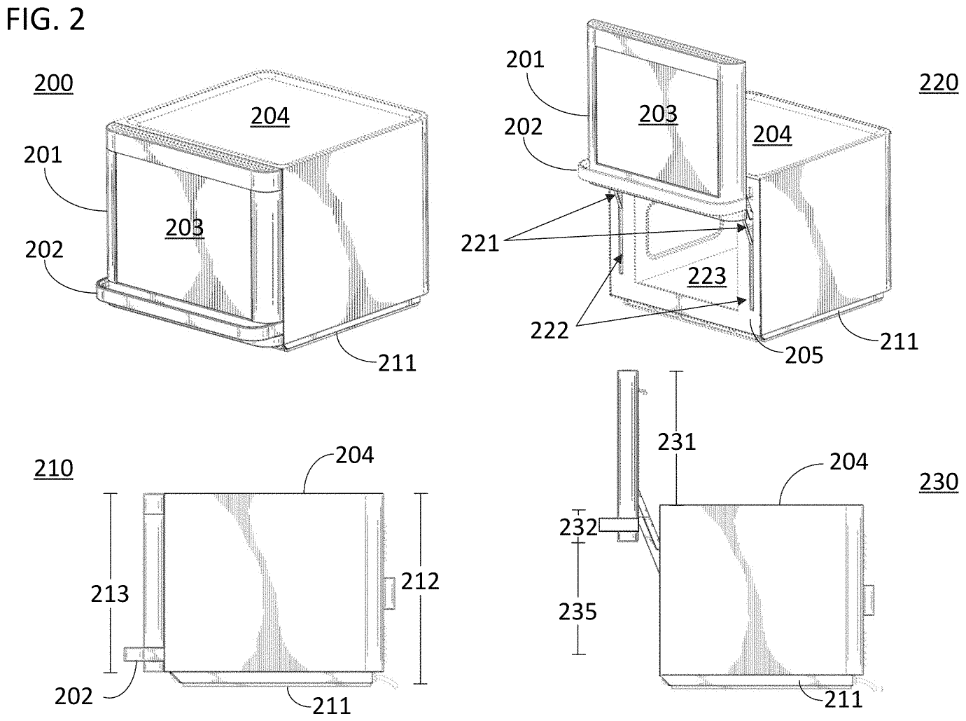

FIG. 2 provides four views of an electronic oven that is in accordance with specific embodiments of the present invention. Views 200 and 210 are perspective and left side views of an example electronic oven in a closed state. The example electronic oven includes a chamber door 201 with a handle 202 and an integrated display 203. Top surface 204 of the electronic oven is also labeled to assist in describing the relative dimensions of the electronic oven. As seen in view 210, the example oven also includes a pedestal 211 for ventilation and power routing. As such, the electronic oven height, as measured in a vertical direction, is defined by dimension 212 while the chamber door height, as measured in a vertical direction, is slightly less and is defined by dimension 213.

Views 220 and 230 are perspective and left side views of the example electronic oven in an open state and can be used to illustrate a benefit associated with certain embodiments of the present invention. In FIG. 2, the means for actuating chamber door 201 includes a hinge mechanism with linkages 221 attached to the chamber door 201 in the lower half of the chamber door. View 230 illustrates the benefits associated with the connection between the electronic oven main body and chamber door being in the lower half of the chamber door. As illustrated, when the electronic oven is in the open state, linkages 221 hold the chamber door up over the electronic oven such that over half of chamber door 201 is above the top surface 204 of the electronic oven. This is illustrated by a comparison of dimension 231 to dimension 213. By increasing the length of linkages 221 the bottom surface of the chamber door can be lifted further to further diminish dimension 232. Indeed, dimension 232 can be decreased to zero. However, given that the core of the electronic oven 205 will generally have at least some width on each side of the heating chamber 223, dimension 232 will generally be nonzero. Regardless, since the means for actuation of the example electronic oven in FIG. 2 are connect on a lower half of the electronic chamber door, the height of the opening for the heating chamber 235 is relatively large, and chamber door 201 can be lifted such that its lower edge is entirely above, or in line with, a top surface of the heating chamber.

View 220 can also be used to illustrate another benefit associated with certain embodiments of the present invention. In certain approaches, the heating chamber door has a chamber door width and the electronic oven had an electronic oven width. Furthermore, the chamber door can be connected to a means of actuation that is entirely covered by the chamber door when the chamber door is in the closed state. As a result, there is no need to save surface area on a front side of the electronic oven and the chamber door width and electronic oven width can be equivalent, thereby maximizing the size of an integrated display on the chamber door. An example of this type of means for actuation can be described with reference to view 220. As illustrated, the electronic oven includes hinges with linkages 221, and hinge recesses 222 in a front surface of the electronic oven core 205. The linkages 221 swing through two cutouts 222 in the front surface of the electronic oven core 205. The remainder of the hinge mechanism operates within the electronic oven core 20 and is not illustrated in FIG. 2. As seen in view 230, the hinge recesses 222 are entirely covered by electronic oven chamber door 201 when the chamber door is in a closed state. Since the connection between the body of the electronic oven and the chamber door is entirely within a back surface of the chamber door, the chamber door has a lateral dimension that is equivalent to the lateral dimension of the electronic oven and is thereby maximized with the size of the electronic oven overall taken as a given

Specific means for actuating the chamber door that are in accordance with specific embodiments of the present invention involve the use of a hinge mechanism. The means for actuating the chamber door can also be augmented with certain features that limit or smooth the amount of external energy applied to actuate the chamber door between states. This is important given that in some cases, the door will be actuated vertically in an upward direction against the pull of gravity, or downward in a direction that will be accelerated by gravity. Furthermore, the chamber door could include a heavy integrated display and RF blocker that would make manually lifting the oven difficult. The hinge mechanism can be attached to the chamber door and can be configured to translate the chamber door between the open state and the closed state in a vertical direction. The hinge mechanism can be connected to the chamber door at a point that is less than half the height of the chamber door. The hinge mechanism can include one or two hinges. In a specific approach involving two hinges, a first hinge can be connected to the chamber door on a first side of the heating chamber and a second hinge can be connected to the chamber door on a second side of the heating chamber. For example, the hinge mechanism could include linkages 221 attached to chamber door 201 in FIG. 2. The two hinges could be mirror image versions of each other.

In specific embodiments of the invention, an individual hinge in the hinge mechanism will include at least two linkages. The linkages can connect one or more mechanical pivots to the chamber door. Each linkage can be attached to the chamber door, either directly or through a separate linkage tie, at a point that is less than half the vertical height of the chamber door. Each hinge could include a power linkage and a guide linkage. The power linkage could be augmented with an active element such as a pneumatic lift, spring, or counterweight to aid an operator when actuating the chamber door and/or to maintain the chamber door in an open state once it has been opened. The guide linkage and power linkages could have different mechanical pivots. The guide linkage and power linkage could have distal ends from their mechanical pivot (or mechanical pivots) that are connected to a linkage tie. The linkage tie could be an integral part of the electronic oven chamber door or could in turn be fastened to the electronic chamber door after the linkage tie is attached to the linkages.

A linkage could include a single arm or multiple arms. The single arm of a linkage could connect the pivot point of the linkage to the chamber door or a linkage tie. The single arm could be the portion of the linkage that supports the torque applied to the chamber door when it is rotated around the mechanical pivot. The second or first arm of the linkage could be used for other purposes such as for limiting the arc or rotation for the linkage by meeting a static portion of the hinge mechanism, or for indicating that the chamber door had reached an open or closed state by meeting a sensor. The second or first arm could also be used to mate with a latch or other fastener to assure that the electronic oven remained in an open or closed state.

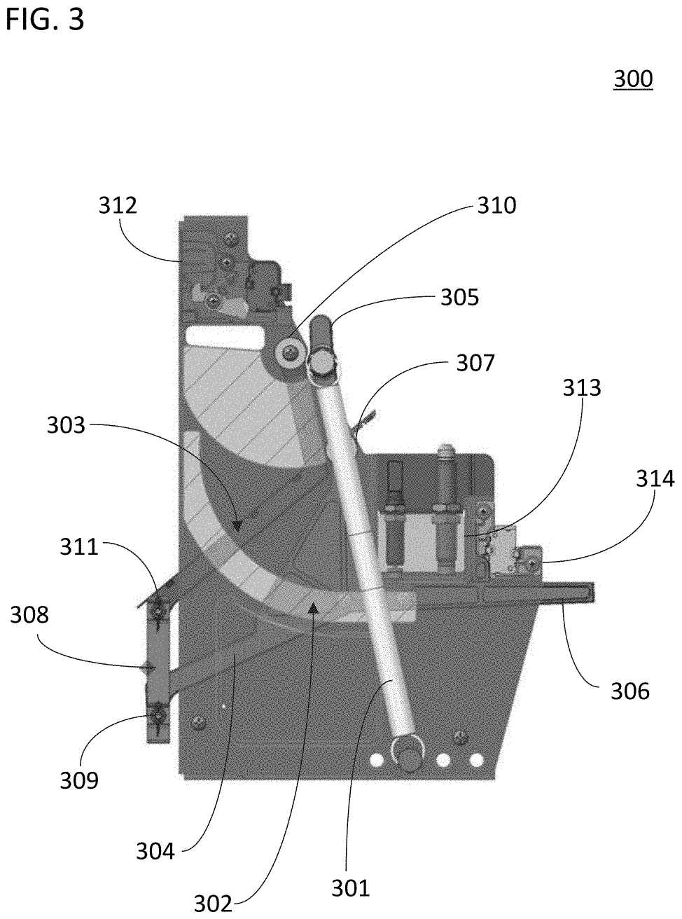

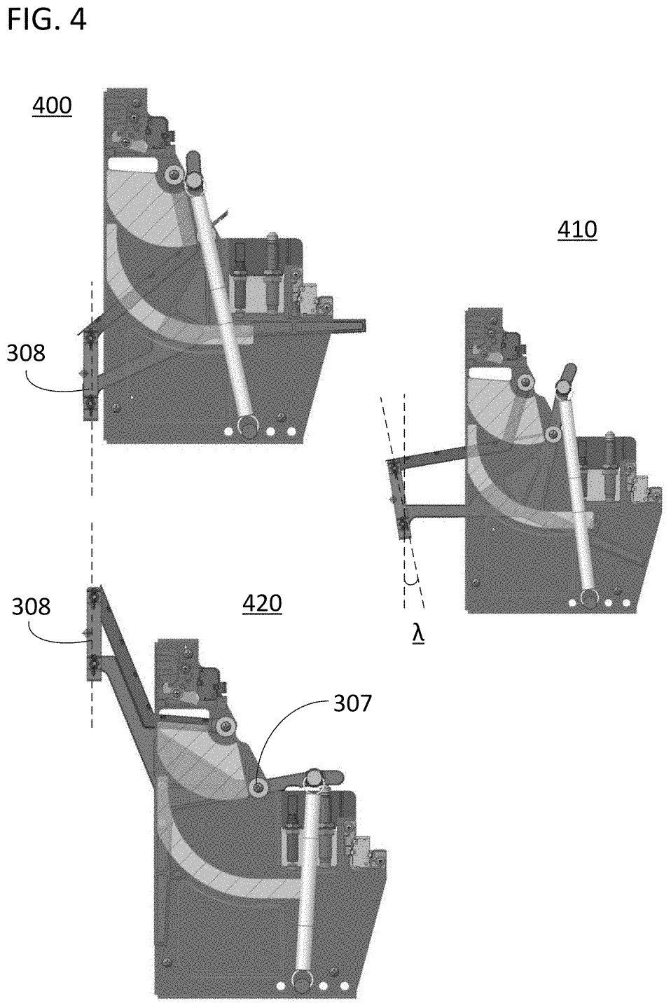

FIG. 3 illustrates a detailed side view of a hinge 300 in an electronic oven in accordance with some of the approaches disclosed herein. Hinge 300 includes a power linkage 302 and a guide linkage 303. Power linkage 302 includes three arms 304, 305, and 306. Spring 301 serves as the active element for power linkage 302 and provides additional force favoring translation of the chamber door in an upward direction as the chamber door is actuated by cancelling the torque applied via arm 304 with countervailing torque applied via arm 305. Guide linkage 303 includes a single arm. Power linkage 302 attaches mechanical pivot 307 to linkage tie 308 at its distal end 309. Guide linkage 303 attaches mechanical pivot 310 to linkage tie 308 at its distal end 311. Guide linkage 303 is used to maintain the chamber door in a near vertical orientation while it is actuated between the open state and the closed state as will be described with reference to FIG. 4.

Hinge 300 also includes features that maintain the chamber door in a closed state and report to the control system of the electronic oven that the chamber door is properly sealed. Hinge 300 includes a mechanical latch 312 configured to mate with a hook latch on a back surface of the chamber door in order to keep the chamber door shut. This latch meets requirements set by certain electronic oven safety standards. The latch can include switches that notify the control system that the chamber door is in a closed state. Furthermore, since certain electronic ovens in accordance with this disclosure include active elements that assist the chamber door in the direction of the open state, the mechanical latch is doubly important as it can counteract the effect of the active element. Hinge 300 also includes a damper 313 that will slow the state transition of the chamber door from the open to the closed state. In this case, arm 306 also serves to fit into contact with a static member of the hinge mechanism 314 to limit the arc of actuation for the chamber door when the chamber is sealed. The static member of the hinge mechanism 314 can include switches that provide safety checks for the system. These safety checks may or may not be implemented in software. The safety checks can be provided for fail safe conditions such as those that do not allow power to be routed to a microwave power source unless the switches indicate that the chamber door is closed. The switches in static member 314 can be configured to sense when arm 360 is in a given position to thereby inform the control system, or the system as a whole (e.g., via a fail-safe that is at a higher level than the control system), that the chamber is sealed.

FIG. 4 illustrates three views of hinge 300 being transitioned between a closed state and an open state. View 400 illustrates hinge 300 in a closed state. View 420 illustrates hinge 300 in an open state. As illustrated, linkage tie 308 is vertical when the heating chamber is in an open state and when the heating chamber is in a closed state. View 410 illustrates hinge 300 at the point where the angle A is at a maximum, where A is the angle by which the chamber door has been tilted away from vertical. Using the disclosed approach, the chamber door and its integrated touch display can be kept within 30 degrees of vertical during the entire transition of the chamber door from the open state to the closed state. The resulting electronic oven provides superior performance to alternatives in which A can exceed this value by providing both superior aesthetics and space savings while the electronic oven is opened.

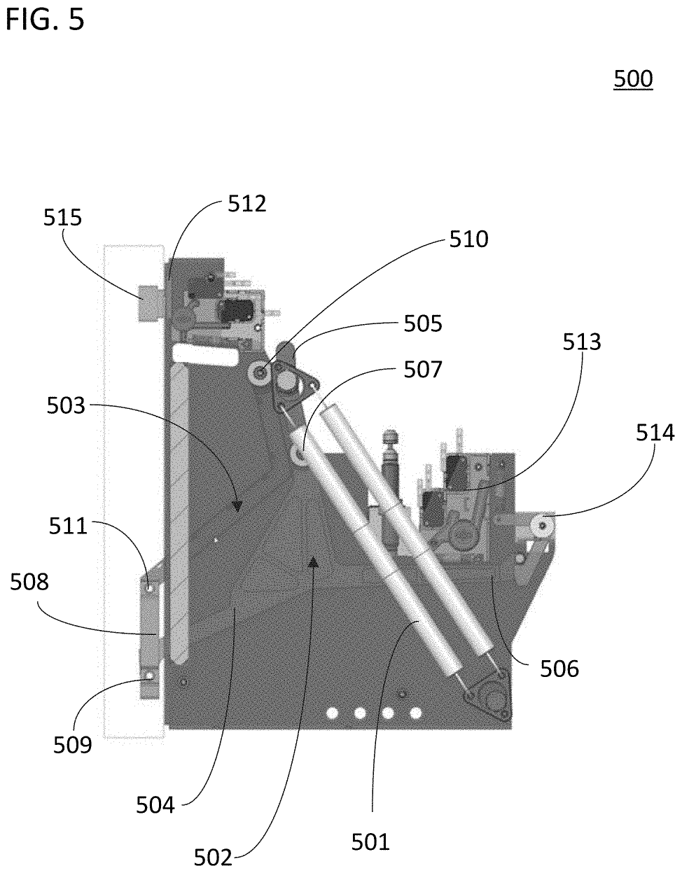

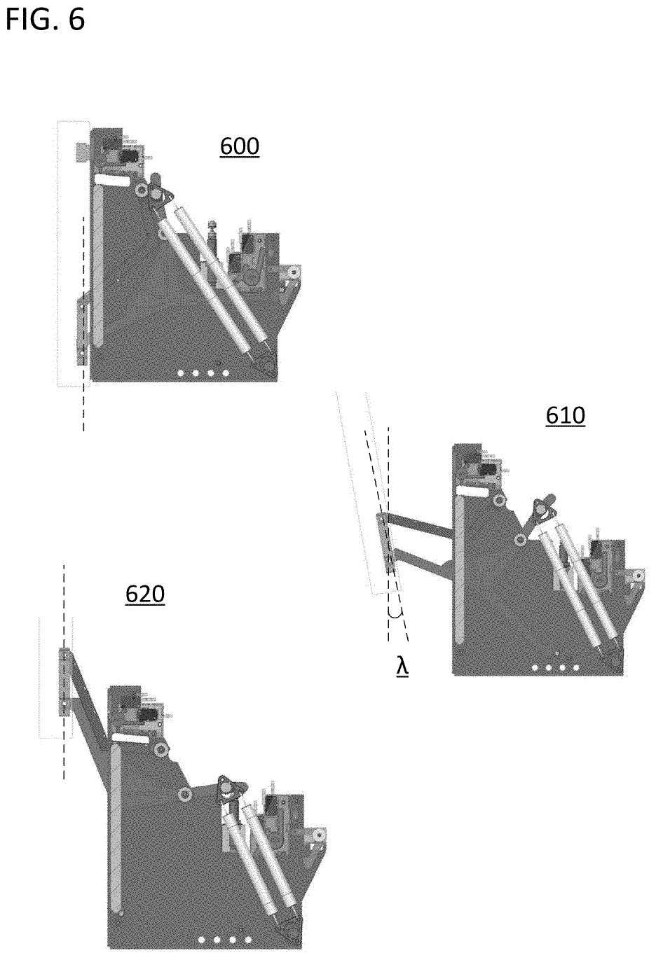

FIG. 5 illustrates a detailed side view of a hinge 500 in an electronic oven in accordance with some of the approaches disclosed herein. Hinge 500 includes a power linkage 502 and a guide linkage 503. Power linkage 502 includes three arms 504, 505, and 506. Spring 501 serves as the active element for power linkage 502 and provides additional force favoring translation of the chamber door in an upward direction as the chamber door is actuated by cancelling the torque applied via arm 504 with countervailing torque applied via arm 505. Guide linkage 503 includes a single arm. Power linkage 502 attaches mechanical pivot 507 to linkage tie 508 at its distal end 509. Guide linkage 503 attaches mechanical pivot 510 to linkage tie 508 at its distal end 511. Guide linkage 503 is used to maintain the chamber door in a near vertical orientation while it is actuated between the open state and the closed state as will be described with reference to FIG. 6.

Hinge 500 also includes features that maintain the chamber door in a closed state and report to the control system of the electronic oven that the chamber door is properly sealed. Hinge 500 includes a mechanical latch 514 configured to mate with a hook latch on a back surface of linkage arm 506 in order to keep the chamber door shut. This latch meets requirements set by certain electronic oven safety standards. Furthermore, since certain electronic ovens in accordance with this disclosure include active elements that assist the chamber door in the direction of the open state, the mechanical latch is doubly important as it can counteract the effect of the active element such as active element 501. Hinge 500 also includes two pressure sensors 512 and 513 that are configured to sense when an embedded element 515 in the chamber door is proximate the electronic oven core, and when arm 506 is in a given position, to thereby inform the control system that the chamber is sealed, and the electronic oven can commence heating.

FIG. 6 illustrates three views of hinge 500 being transitioned between a closed state and an open state. View 600 illustrates hinge 500 in a closed state. View 620 illustrates hinge 500 in an open state. As illustrated, linkage tie 308 is vertical when the heating chamber is in an open state and when the heating chamber is in a closed state. View 610 illustrates hinge 500 at the point where the angle A is at a maximum, where A is the angle by which the chamber door has been tilted away from vertical. Using the disclosed approach, the chamber door and its integrated touch display can be kept within 30 degrees of vertical during the entire transition of the chamber door from the open state to the closed state. The resulting electronic oven provides superior performance to alternatives in which A can exceed this value by providing both superior aesthetics and space savings while the electronic oven is opened.

Various design parameters associated with FIGS. 3 and 5 can be selected through the use of CAD tools to adjust the perceived weight of the chamber door as it is transitioned between the closed and open state and to keep the maximum value of A during the actuation of the chamber door below a desired value. In particular, the relative locations of pivot points (310 and 307/510 and 507), the dimensions of arms 304, 504, 305 and 505, and the relative size and position of springs 301 and 501 can be independently set to adjust the weight of the chamber door. Adjusting the weight can involve assuring the perceived weight remains stable through the entire range of actuation and setting the maximum or average perceived weight. In specific approaches, the above parameters are selected such that the perceived weight will be nearly zero through the entire range of actuation. Once these parameters are set, additional parameters such at the dimensions of guide linkages 303 and 503, and the relative position of pivots 307 and 507 to the overall oven can be set to assure that the maximum value of A during the actuation of the chamber door remains below a desired value.

In specific embodiments of the present invention, the chamber door will include an integrated display. The integrated display can be a touch screen. The display can cover an entire lateral extent of the electronic oven. The display can cover an entire vertical extent of the electronic oven chamber door, and can have a height greater than sixty percent of the height of the electronic oven. In approaches in which the integrated display is a touch screen, a touch screen controller can be instantiated on an ASIC, or other integrated circuit, which is in turn integrated in the chamber door or located with the other control electronics in the core of the electronic oven. In either case, power and data can be routed to the display from the core of the electronic oven. The data can be sent from a main controller for the electronic oven such as an operating system instantiated on a dedicated processor.

Power and data can be routed from the core of the electronic oven to the display in numerous ways. For example, wires for routing power and data can extend from the core to the display. The wires could be concealed within cutouts or retraction ports when the electronic oven is in a closed state. The wires could then be exposed and pulled taut when the electronic oven is in an open state. As another example, the wire could be integrated with a hinge mechanism of the electronic oven such that they are never visible during normal operation when the electronic oven is in the closed or open state. A channel formed on a surface of one of the hinges could be used to route a power and/or data wire from the electronic oven to the display in such a way that no wires were visible when the electronic oven was in a closed or an open state. As another example, power could be routed to the electronic oven through inductive coupling to a rechargeable battery in the chamber door that was charged when the electronic oven was in a closed state. Data could likewise be sent through this inductive coupling when the chamber door was in a closed state. The chamber door could then either provide its own power and not receive data when in the open state, or it could continue to receive power through a different wireless connection when in the open state.

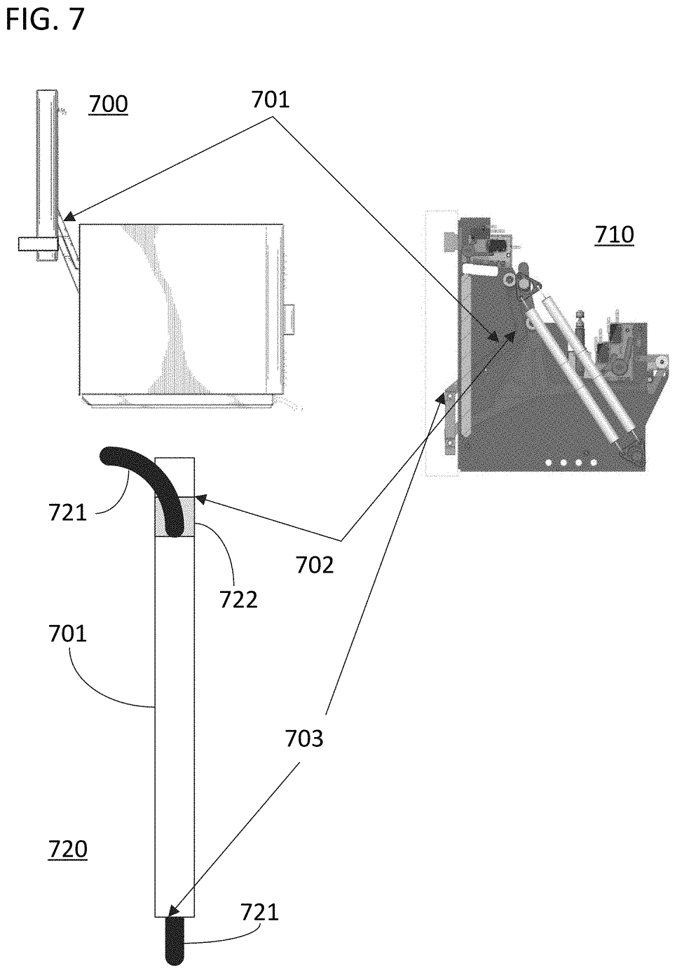

FIG. 7 illustrates a hinge power routing system for a hinge mechanism in accordance with some of the approaches disclosed herein. FIG. 7 includes a side view 700 of an electronic oven. The electronic oven includes a hinge mechanism with first and second hinges. One of those hinges is illustrated in view 710. A guide linkage 701 of the hinge is shown in both view 700, 710, and 720. View 720 is a top down view of the linkage. As shown, guide linkage 701 includes inflection 702 and distal end 703. The guide linkage includes a channel which is partially covered and is used to route a power cable 721 through the channel. The power cable can be connected to the display on the chamber door. The channel is through the center of linkage 701 and is bracketed by the walls of the linkage.

Using the approach illustrated in FIG. 7, the power and/or data can be routed to the display on the chamber door without any associated wiring being visible or accessible while the electronic oven is open. At inflection 702, the wire is routed up and out from the channel through an opening 722 in the top surface of the channel. Opening 722 is located within the core of the electronic oven when the electronic oven is in the open state. As a result, opening 722 is not exposed and power cable 721 can be routed within the core of the electronic oven. At distal end 721, the power cable can be threaded through a hollow end of the linkage and a hole in the back surface of the chamber door. The area around the holes could be covered by, and be in direct contact with, the channel of the linkage such that the wire was not accessible or visible when the electronic oven was in an open state. Although not illustrated, a data cable can be threaded through the channel in the same ways as the illustrated power cable is threaded.

In specific embodiments of the present invention in which a hinge mechanism is utilized to actuate the chamber door, any cutouts formed by the hinge can be sealed using a hinge cutout sealing mechanism. The sealing mechanism can move into place when the hinge is in an open state. The hinge recess can be covered by a portion of the hinge when the chamber door is in the open state. In particular, if the hinge includes linkages that swing through the cutout, the area left behind once the linkages have done so can be sealed by a sheet of material that swings into place along with the movement of the hinge. For example, a sheet of material can rotate along an axis that is located alongside and parallel to a main surface of the cutout. In another example, the sheet of material can be an additional arm of the linkage that moves along with the linkage but settles into a position such that it blocks the cutout when the hinge is open.

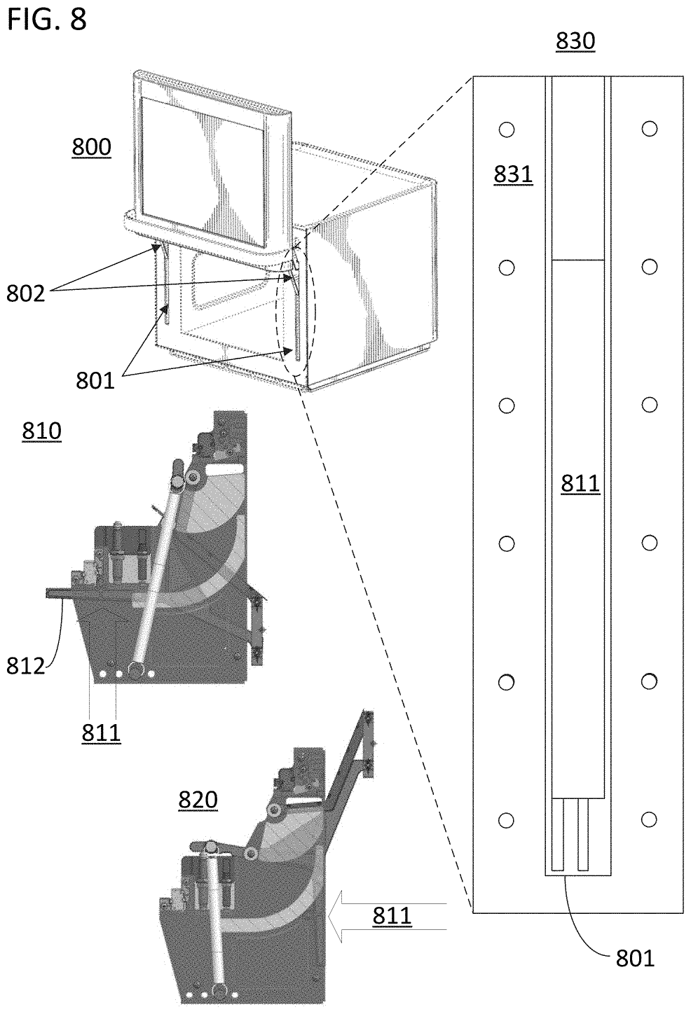

FIG. 8 illustrates the operation of a hinge cutout sealing mechanism in accordance with some of the approaches disclosed herein in which an arm of a linkage is used to seal the cutout. FIG. 8 includes view 800 which shows an electronic oven with two hinge recesses 801 and two sets of linkages 802. Views 810 and 820 show side views of one of the hinges in the electronic oven. The chamber door is in a closed state in view 810 and an open state in view 820. As illustrated, a front surface of one arm of the power linkage 811 is rotated forward towards the front surface of the core of the electronic oven 831 as the chamber door is opened. As a result, the arm of the linkage that is connected to the chamber door swings through the hinge cutout first and is then followed by a second arm. Surface 811 of the power linkage is configured to seal the cutout when the chamber door is in an open state by having the same size as the cutout or by being slightly larger than the cutout. Surface 811 can also be treated with or covered by a compressive material to form a seal with the oven core.

In accordance with specific embodiments of the present invention, a portion of the hinge mechanism can also be used to contact a pressure sensor to inform the electronic oven that it is in a closed state. The pressure sensor can be positioned to engage with an arm of a linkage such as linkage 812 in FIG. 8. The pressure sensor can be designed to cut all power to the energy source of the electronic oven (such as a magnetron) when the pressure sensor is not engaged. The pressure sensor could also be located on a front surface of the electronic oven core and directly sense when the chamber door has been pressed against a front surface of the electronic oven core. The pressure sensors could also be replaced with any kind of proximity sensor including magnetometers and other sensing technologies. In specific approaches, the electronic oven will include more than one pressure or proximity sensor and will be configured to prevent the electronic oven from generating heat energy if any of the sensors detect that the electronic oven is not in a closed state.

While the specification has been described in detail with respect to specific embodiments of the invention, it will be appreciated that those skilled in the art, upon attaining an understanding of the foregoing, may readily conceive of alterations to, variations of, and equivalents to these embodiments. Although examples in the disclosure were generally focused on ovens in which the chamber door was translated upwards to open the oven, similar approaches are applicable to chamber doors that are translated downwards to open the oven. For example, a hinge mechanism could be connected to the upper half of an electronic oven door that was opened vertically downwards to assure the chamber opening was fully exposed when the chamber door was opened. Although examples in the disclosure included heating items through the application of electromagnetic energy, any other form of heating could be used in combination or in the alternative. Some of the approaches disclosed herein can be applied to a chamber door for any heating chamber, not just for a heating chamber of an electronic oven. These and other modifications and variations to the present invention may be practiced by those skilled in the art, without departing from the scope of the present invention, which is more particularly set forth in the appended claims.

What is claimed is:

1. An electronic oven, comprising:
a hinge mechanism;
a heating chamber;
a chamber door connected to the hinge mechanism; and
an integrated touch display on the chamber door;
wherein the chamber door seals the heating chamber in a closed state and reveals the heating chamber in an open state; and
wherein the hinge mechanism is configured to move the chamber door vertically between the open state and the closed state.

2. The electronic oven of claim 1, wherein:
the integrated touch display provides a sole control panel for the electronic oven.

3. The electronic oven of claim 1, wherein:
at least half of the chamber door is above a top surface of the electronic oven when the chamber door is in the open state.

4. The electronic oven of claim 1, wherein:
the electronic oven has an electronic oven height measured in a vertical direction;
the chamber door has a chamber door height measured in the vertical direction; and
the chamber door height is at least sixty percent of the electronic oven height.

5. The electronic oven of claim 1, further comprising:
a first hinge in the hinge mechanism;
a first linkage in the first hinge;
a second linkage in the first hinge; and
a linkage tie connecting a distal end of the first linkage to a distal end of the second linkage;
wherein the linkage tie is vertical when the heating chamber is in the open state and when the heating chamber is in the closed state.

6. The electronic oven of claim 1, further comprising:
a first hinge in the hinge mechanism;
a power linkage in the first hinge;
a guide linkage in the first hinge; and
an active element connected to the power linkage;
wherein the power linkage is connected to the chamber door at a point which is less than half a vertical height of the chamber door; and
wherein the guide linkage is connected to the chamber door at a second point which is also less than half the vertical height of the chamber door.

7. The electronic oven of claim 1, further comprising:
a first hinge in the hinge mechanism; and
a second hinge in the hinge mechanism;
wherein the chamber door is connected to: (i) the first hinge on a left side of the heating chamber; and (ii) the second hinge on a right side of the heating chamber;
wherein the chamber door has a chamber door width;
wherein the electronic oven has an electronic oven width; and
wherein the chamber door width is equivalent to the electronic oven width.

8. The electronic oven of claim 1, further comprising:
a first hinge in the hinge mechanism; and
a second hinge in the hinge mechanism;
wherein the chamber door is connected to: (i) the first hinge on a left side of the heating chamber; and (ii) the second hinge on a right side of the heating chamber; and
wherein the integrated touch display is kept within thirty degrees of vertical during an entire transition of the chamber door from the open state to the closed state.

9. The electronic oven of claim 1, further comprising:
a first hinge in the hinge mechanism;
a channel on a surface of the first hinge; and
a power cable routed through the channel and connected to the integrated touch display.

10. The electronic oven of claim 1, further comprising:
an electronic oven core surrounding the heating chamber;
a first hinge in the hinge mechanism; and
a hinge recess in a front surface of the electronic oven core;
wherein the hinge recess is covered by a portion of the first hinge when the chamber door is in the open state; and
wherein the hinge recess is covered by the chamber door when the chamber door is in the closed state.

11. The electronic oven of claim 10, wherein:
the first hinge includes a first linkage;
the first linkage includes: (i) a first arm connected to the chamber door; (ii) and a second arm; and
the portion of the first hinge that covers the hinge recess when the chamber door is in the open state is the second arm.

12. The electronic oven of claim 1, further comprising:
a first hinge in the hinge mechanism;
a magnetron;
an injection port in the heating chamber;
a waveguide coupling the magnetron to the injection port; and
a pressure sensor that cuts power to the magnetron when it is not engaged;
wherein the first hinge includes a first linkage;
wherein the first linkage includes: (i) a first arm connected to the chamber door; (ii) and a second arm; and
wherein the second arm engages the pressure sensor when the chamber door is in the closed state.

13. An electronic oven having an electronic oven height in a vertical direction and comprising:
a hinge mechanism;
a heating chamber; and
a chamber door connected to the hinge mechanism and having a chamber door height in the vertical direction;
wherein the chamber door is configured to seal the heating chamber in a closed state and reveal the heating chamber in an open state;
wherein the hinge mechanism is configured to move the chamber door between the open state and the closed state in the vertical direction; and
wherein the chamber door height is at least sixty percent of the electronic oven height.

14. The electronic oven of claim 13, further comprising:
an integrated touch display on the chamber door;
wherein the integrated touch display provides a sole control panel for the electronic oven.

15. The electronic oven of claim 13, wherein:
at least half of the chamber door is above a top surface of the electronic oven when the chamber door is in the open state.

16. The electronic oven of claim 13, further comprising:
a first hinge in the hinge mechanism;
a first linkage in the first hinge;
a second linkage in the first hinge; and
a linkage tie connecting a distal end of the first linkage to a distal end of the second linkage;
wherein the linkage tie is vertical when the heating chamber is in the open state and when the heating chamber is in the closed state.

17. The electronic oven of claim 13, further comprising:
a first hinge in the hinge mechanism;
a power linkage in the first hinge;
a guide linkage in the first hinge; and
an active element connected to the power linkage;
wherein the power linkage is connected to the chamber door at a point which is less than half the vertical height of the chamber door; and
wherein the guide linkage is connected to the chamber door at a second point which is also less than half the vertical height of the chamber door.

18. The electronic oven of claim 14, further comprising:
a first hinge in the hinge mechanism; and
a second hinge in the hinge mechanism;
wherein the chamber door is connected to: (i) the first hinge on a left side of the heating chamber; and (ii) the second hinge on a right side of the heating chamber;
wherein the chamber door has a chamber door width;
wherein the electronic oven has an electronic oven width; and
wherein the chamber door width is equivalent to the electronic oven width.

19. The electronic oven of claim 14, further comprising:
a first hinge in the hinge mechanism; and
a second hinge in the hinge mechanism;
wherein the chamber door is connected to: (i) the first hinge on a left side of the heating chamber; and (ii) the second hinge on a right side of the heating chamber;
wherein the integrated touch display is kept within thirty degrees of vertical during an entire transition of the chamber door from the open state to the closed state.

20. The electronic oven of claim 14, further comprising:
a first hinge in the hinge mechanism;
a channel on a surface of the first hinge; and
a power cable routed through the channel and connected to the integrated touch display.

21. The electronic oven of claim 13, further comprising:
an electronic oven core surrounding the heating chamber;
a hinge recess in a front surface of the electronic oven core; and
a first hinge in the hinge mechanism;
wherein the first hinge includes a first linkage;
wherein the first linkage includes: (i) a first arm connected to the chamber door; (ii) and a second arm;
wherein the second arm covers the hinge recess when the chamber door is in the open state; and
wherein the chamber door covers the hinge recess when the chamber door is in the closed state.

22. The electronic oven of claim 13, further comprising:
a first hinge in the hinge mechanism;
a magnetron;
an injection port in the heating chamber;
a waveguide coupling the magnetron to the injection port; and
a pressure sensor that cuts power to the magnetron when it is not engaged;
wherein the first hinge includes a first linkage;
wherein the first linkage includes: (i) a first arm connected to the chamber door; (ii) and a second arm; and
wherein the second arm engages the pressure sensor when the chamber door is in the closed state.

23. An electronic oven comprising:
a hinge mechanism including a first hinge and a second hinge;
a heating chamber;
a chamber door connected to: (i) the first hinge on a left side of the heating chamber; and (ii) the second hinge on a right side of the heating chamber; and
an integrated touch display on the chamber door.

24. The electronic oven of claim 23, wherein:
the integrated touch display provides a sole control panel for the electronic oven.

25. The electronic oven of claim 23, wherein:
at least half of the chamber door is above a top surface of the electronic oven when the chamber door is in an open state.

26. The electronic oven of claim 23, wherein:
the integrated touch display is kept within thirty degrees of vertical during an entire transition of the chamber door from an open state to a closed state.

27. The electronic oven of claim 23, wherein:
the chamber door seals the heating chamber in a closed state and reveals the heating chamber in an open state;
the hinge mechanism is configured to move the chamber door between the open state and the closed state vertically relative to the electronic oven;
the electronic oven has an electronic oven height measured in a vertical direction;
the chamber door has a chamber door height measured in the vertical direction; and
the chamber door height is at least sixty percent of the electronic oven height.

28. The electronic oven of claim 23, further comprising:
a power linkage in the first hinge;
a guide linkage in the first hinge; and
an active element connected to the power linkage;
wherein the power linkage is connected to the chamber door at a point which is less than half a vertical height of the chamber door; and
wherein the guide linkage is connected to the chamber door at a second point which is also less than half the vertical height of the chamber door.

29. The electronic oven of claim 23, further comprising:
a channel on a surface of the first hinge; and
a power cable routed through the channel and connected to the integrated touch display.

30. The electronic oven of claim 23, further comprising:
an electronic oven core surrounding the heating chamber; and
a hinge recess in a front surface of the electronic oven core;
wherein the first hinge includes a first linkage;
wherein the first linkage includes: (i) a first arm connected to the chamber door; (ii) and a second arm;
wherein the second arm covers the hinge recess when the chamber door is in an open state; and
wherein the chamber door covers the hinge recess when the chamber door is in a closed state.
